(19) United States
(12) Patent Application Publication
(10) Pub. No.: US 2014/0034685 A1
(43) Pub. Date: Feb. 6, 2014

(54) Pressure Sprayer

(71) Applicant: The Fountainhead Group, Inc., Pressure Sprayer, NY (US)

(72) Inventors: Thomas Meyers, Cayuga, NY (US); Mark A. Ferguson, Memphis, NY (US); Tyler Watson, Skaneateles, NY (US); Jeffrey D. Nicolia, Oneida, NY (US)

(73) Assignee: THE FOUNTAINHEAD GROUP, INC., New York Mills, NY (US)

(21) Appl. No.: 13/749,285

(22) Filed: Jan. 24, 2013

Related U.S. Application Data
(60) Provisional application No. 61/590,291, filed on Jan. 24, 2012.

(51) Int. Cl. B65D 83/00; B67D 3/00

(52) U.S. Cl. CPC B05B 11/30
USPC 222/401; 222/530

(57) ABSTRACT

A sprayer that includes a tank for containing a liquid pesticide, herbicide, or the like, a pump for pressurizing the liquid contained within the tank, and a hose and wand assembly for dispersing the pressurized liquid onto an area of interest, such as weeds. The tank includes an opening formed through its top surface through which liquid can be poured into tank. A wide mouthed funnel defines the opening to assist in preventing fluid from spilling while being poured. The bottom of the tank is attached to a base unit that provides a reservoir for any liquids dripping on the exterior of the tank, while also providing a flared region in which the end of the wand can be positioned when not in use. A wand retaining clip is attached to the exterior of the funnel to secure the wand while not in use and further to direct the end of the wand into the flared region formed in the base of the unit.

### REFERENCE TO RELATED APPLICATION

The present application relates and claims priority to U.S. Provisional Application Ser. No. 61/590,291, filed Jan. 24, 2012, the entirety of which is hereby incorporated by reference.

### BACKGROUND

The present invention relates generally to pressure sprayers, and more particularly to an R style sprayer for herbicides, pesticides, and the like.

1. Field of Invention

R style sprayers are a form of hand carried, pump sprayer that are typified by having a wider base and narrower top. This structure permits the bulk of the weight to be more broadly dispersed beneath the center of gravity of the sprayer unit making carrying it less cumbersome. R style sprayers, as with other hand carried sprayers, come equipped with an elongated wand connected to the tank via a hose that carries the liquid from a pressurized interior region within the tank and disperses it via a nozzle. The wand is typically actuated via a handle. The liquid is typically pressurized view an internal pump mechanism that is actuated via a handle located on the top of the tank and is movable along a vertical axis. A diaphragm or other pressure enabling structure is located within the tank and retains air that is pumped into the pressure region via the pump handle.

It is typical for multiple types of nozzles to be provided with a sprayer; an adjustable nozzle, a flat fan nozzle, and a foaming nozzle. The brass adjustable nozzle makes it possible to control the form of the spray, from a soft mist to a forceful stream. The flat fan nozzle creates a wide, fan-shaped spray that is good for reaching beneath large plantings or for applying treatments in a sweeping fashion. The foaming nozzle causes the concentrate to come out as foam. This application is effective when you need the spray contents to remain on the weeds for a longer time.

2. Background Art

Hand carried pressure sprayers do not typically provide an on-board structure for storing the extra nozzles provided with the sprayer. Nor do the sprayers typically provide a convenient structure to retain the wand when not in use. Finally, if liquid seeps from the cap of the sprayer or drips off the end of the wand, the liquid will typically run down the exterior of the tank and drip onto the user.

3. Objects and Advantages

It is a principal object and advantage of the present invention to provide a sprayer that includes structure for securing the extra nozzles when not in use.

It is another object and advantage of the present invention to provide a sprayer that includes structure for securely retaining the wand when it is not in use.

It is a further object and advantage of the present invention to provide a sprayer that includes a base that provides stability to the unit when it is placed on the ground and also collects liquid dripped from the sprayer.

It is yet an additional object and advantage of the present invention to provide a fill opening that is defined by a wide mouth funnel to ease the pouring of liquid into the tank.

Other objects and advantages of the present invention will in part be obvious, and in part appear hereinafter.

### SUMMARY OF THE INVENTION

In accordance with the foregoing objects and advantages, the present invention provides a sprayer comprising a tank that is wider at its base than at its top and includes a pair of nozzle retaining appendages extending outwardly from its exterior surface adjacent its top end. The sprayer further comprises a wand retaining clip integrally associated with the tank's cap. A base unit is attached to the tank's bottom end and is characterized by a top that flares slightly outwardly such that the end of the wand when not in use can be positioned within the confines of the base. Therefore, any liquid dripping off the end of the wand will be collected within the base and not fall directly on the user or on the ground. The fill opening at the top of the tank is defined by a wide mouth funnel that aides in pouring liquid into the tank with minimal spilling.

### BRIEF DESCRIPTION OF THE DRAWINGS

FIG. 1 is a perspective view of for a sprayer;

FIG. 2 is a front elevation view thereof;

FIG. 3 is a rear elevation view thereof;

FIG. 4 is a first side elevation view thereof;

FIG. 5 is second side elevation view thereof;

FIG. 6 is a top plan view thereof;

FIG. 7 is a bottom plan view thereof;

FIG. 8 is an enlarged perspective view of the top of the tank;

FIG. 9 is an enlarged perspective view of the wand retaining clip;

FIG. 10 is an enlarged perspective view of the top of the base; and

FIG. 11 is an enlarged perspective view of the bottom of the base.

### DETAILED DESCRIPTION

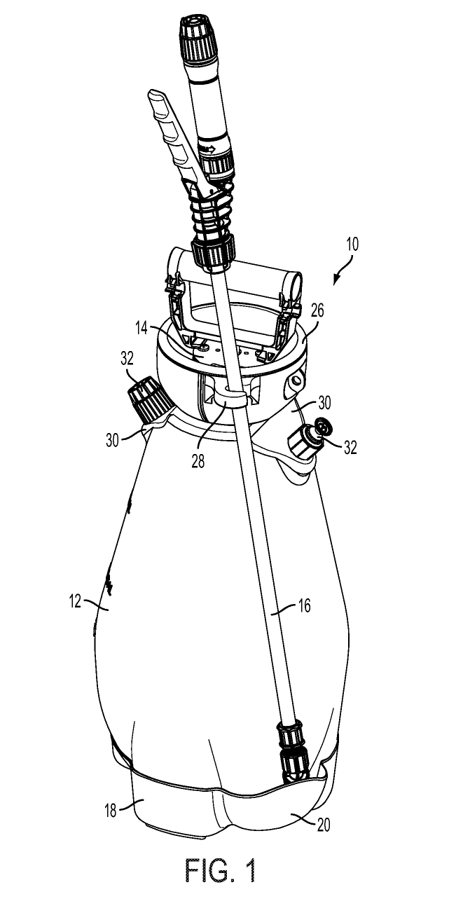

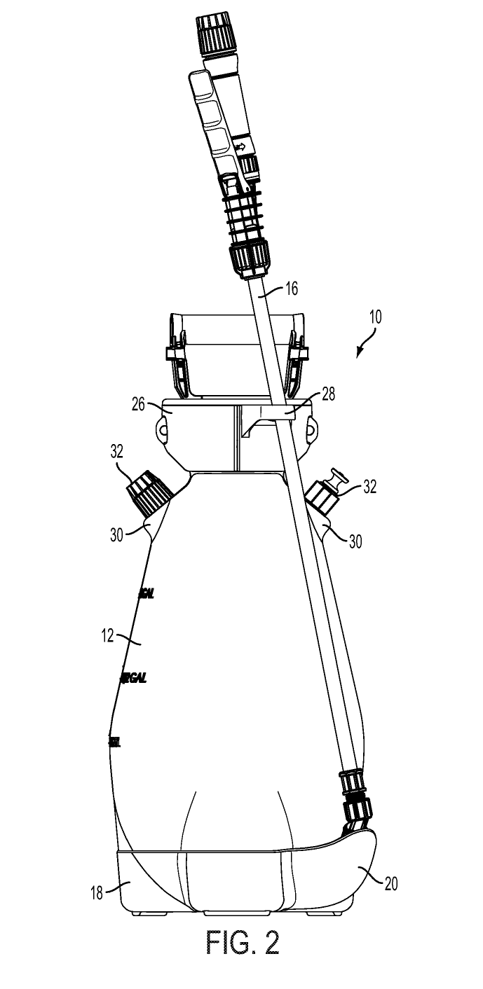

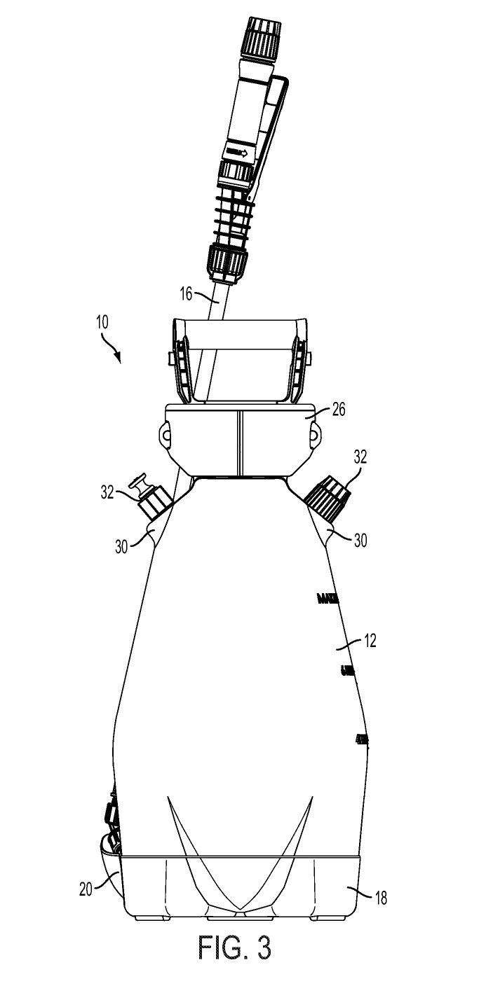

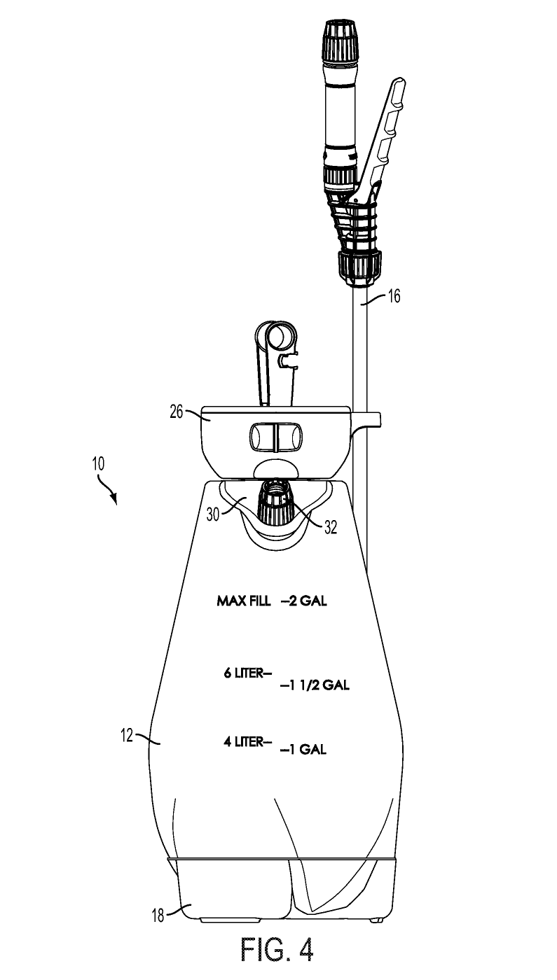

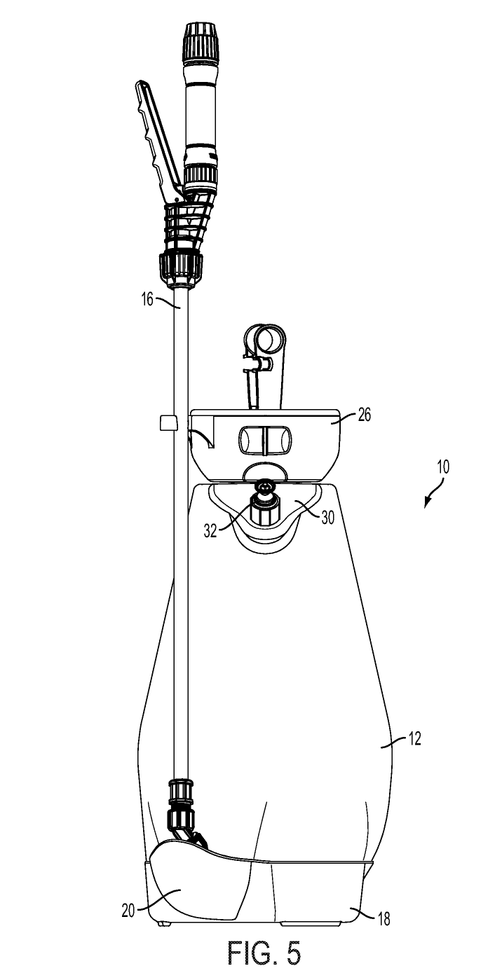

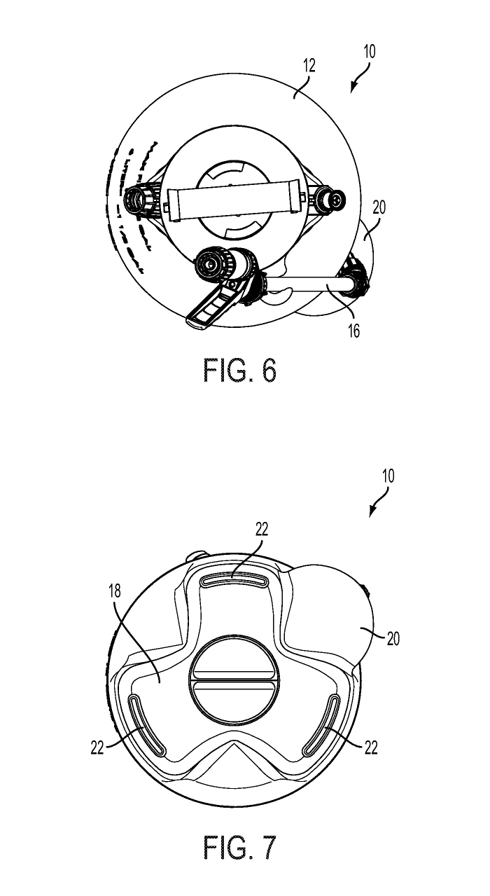

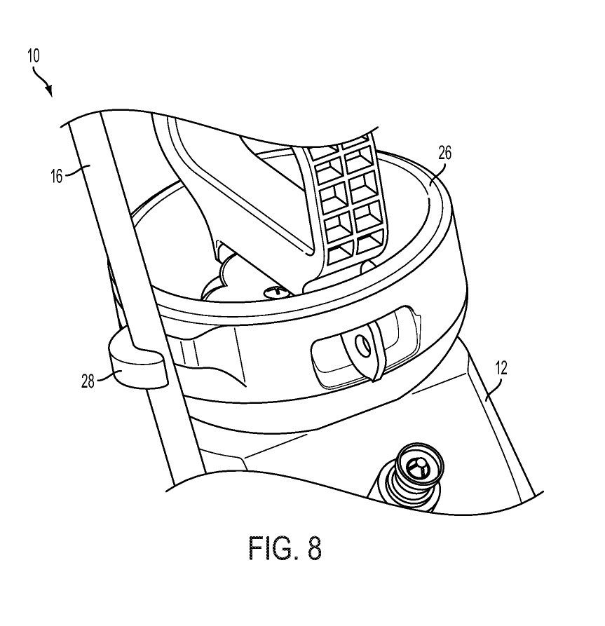

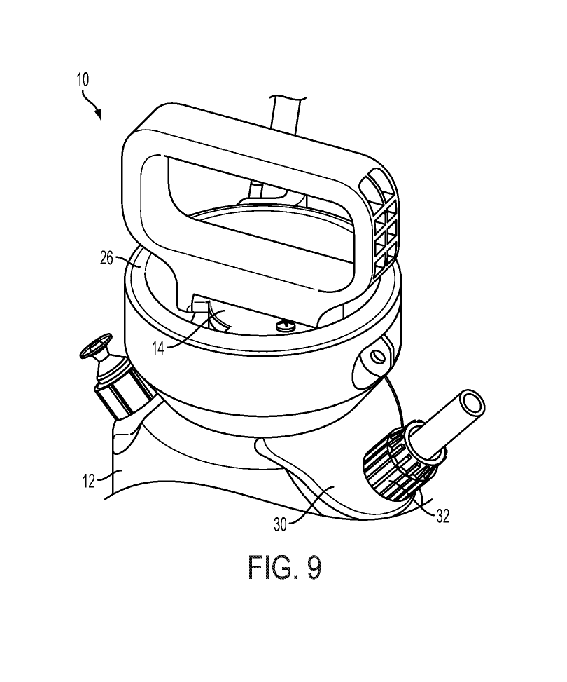

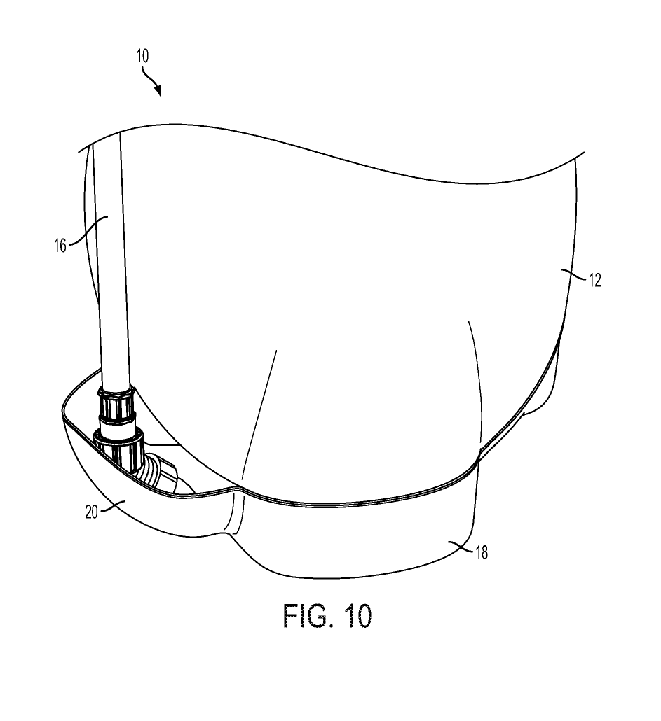

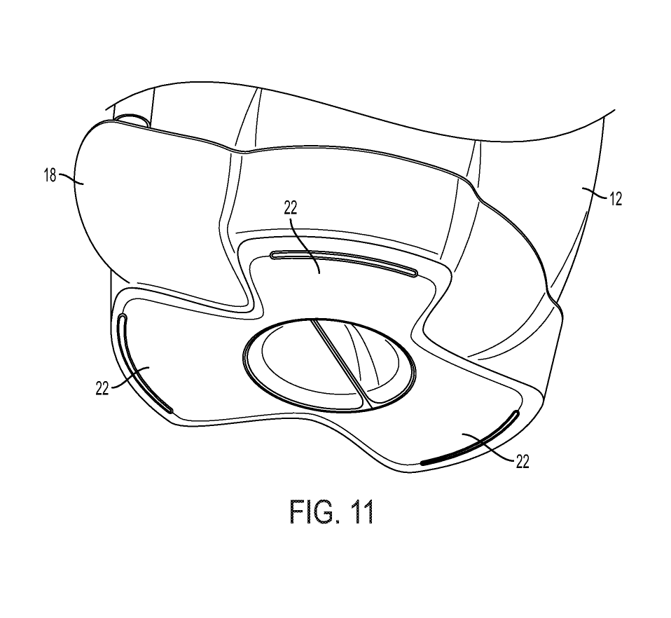

Referring now to the drawings in which like reference numerals refer to like parts throughout, there is seen in FIG. 1 a sprayer designated generally by reference numeral 10 comprising a tank 12, a cap 14 for sealing the tank, and a spray wand 16. A hose (not seen) connects the wand to the interior region of the sprayer in a conventional manner, and a pump handle 16 provides the mechanism for pressurizing the tank's interior region where the liquid is stored, again, in a conventional manner.

Sprayer 10 further comprises a base 18 that connects to the bottom end of the tank 12. Base 18 is cup-shaped and includes a flared region (a “flare”) 20 extending outwardly away from the exterior surface of the tank. This slight flare 20 creates space in which the end of wand 16 can be positioned when not in use. In addition, the interior shape of base 18 in the vicinity of the flare receives the end of wand 16 such that the spray end of the wand will be pointed inwardly, thereby causing any liquid dripping from the wand to simply be captured within the base. The bottom surface of base 18 comprises a plurality of feet 22 (see FIGS. 7 and 11) that protect the unit when it is dragged on an abrasive surface such asphalt.

The top of tank 12 is equipped with a cap 14 that provides access to an opening through which liquid can be poured into the tank (the cap also provides access for the pump mechanism to pass with the handle of the pump being positioned adjacent the cap, in a conventional and well understood manner). Immediately surrounding and defining the opening is a wide mouth funnel 26 that serves to direct liquid through the opening and largely preventing spilling of the liquid as it is poured into the tank.

Integral with the side of wide mouth funnel 26 (or alternatively, integral with tank 12) is a clip 28 used to retain wand 16 when it is not in use. Clip 28 is oriented such that wand 16 is directed at an angle along the exterior of tank 12 such that the tip of wand 16 will be positioned within base 18 in the space defined by the flare 20.

Sprayer 10 further comprises a pair of nozzle retaining members 30 that are either integrally molded into the exterior of tank 12 or attached thereto. Nozzle retaining members 30 securely hold the extra spray nozzles 32 provided with sprayer that are not being used on wand 16.

What is claimed is:

1) A sprayer, comprising:
a) a tank having a top end and a bottom end and adapted to contain liquid in a region adapted to be pressurized;
b) a wand fluidly connected to said region adapted to be pressurized;
c) a pump adapted to increase pressure within said region adapted to be pressurized; and
d) a base connected to said bottom of said tank and having a flared region adapted to receive a portion of said wand.

2) A sprayer, comprising:
a) a tank having a top end and a bottom end and adapted to contain liquid in a region adapted to be pressurized and an opening formed through said top end;
b) a wand fluidly connected to said region adapted to be pressurized;
c) a pump adapted to increase pressure within said region adapted to be pressurized; and
d) a funnel attached to said tank and defining a funneled passage to said opening.

3) A sprayer, comprising:
a) a tank having a top end and a bottom end and adapted to contain liquid in a region adapted to be pressurized;
b) a wand fluidly connected to said region adapted to be pressurized;
c) a pump adapted to increase pressure within said region adapted to be pressurized; and
d) a clip attached to said tank and adapted to retain said wand.
